(19) United States
(12) Patent Application Publication
(10) Pub. No.: US 2016/0261619 A1
(43) Pub. Date: Sep. 8, 2016

(54) SHIP GATEWAY APPARATUS AND STATUS INFORMATION DISPLAYING METHOD THEREOF

(71) Applicant: Electronics and Telecommunications Research Institute, Daejeon (KR)

(72) Inventors: Kwang Il LEE, Daejeon (KR); Moon Sub SONG, Daejeon (KR); Joo Chan SOHN, Daejeon (KR); Byung Tae JANG, Daejeon (KR)

(73) Assignee: Electronics and Telecommunications Research Institute, Daejeon (KR)

(21) Appl. No.: 15/056,312

(22) Filed: Feb. 29, 2016

(30) Foreign Application Priority Data
Mar. 3, 2015 (KR) 10-2015-0029751
Jan. 20, 2016 (KR) 10-2016-0007017

(51) Int. Cl. H04L 29/06

(52) U.S. Cl. CPC H04L 63/1416; H04L 63/02

(57) ABSTRACT

Provided are a ship gateway apparatus and a status information displaying method thereof. The ship gateway apparatus includes a network interface configured to provide an interface with an external network system, a data input unit configured to receive, through the network interface, data transmitted from the external network system, a network connection establisher configured to establish a connection with the external network system, a data processor configured to process data, based on establishment information about the connection with the external network system established by the network connection establisher, a data output unit configured to output data, obtained through processing by the data processor, to the network interface, and a switching unit configured to transfer data, input through the data input unit, to the data processor and output the data, obtained through processing by the data processor, to the data output unit.

### CROSS-REFERENCE TO RELATED APPLICATIONS

This application claims priority under 35 U.S.C. §119 to Korean Patent Application No. 10-2015-0029751, filed on Mar. 3, 2015, and No. 10-2016-0007017, filed on Jan. 20, 2016, the disclosure of which is incorporated herein by reference in its entirety.

### TECHNICAL FIELD

The present invention relates to a ship gateway apparatus and a status information displaying method thereof, and more particularly, to a ship gateway apparatus and a status information displaying method thereof, which maintains security of a ship's internal system connected to an external network system and displays status information about the ship's internal system to notify a risk situation.

### BACKGROUND

Generally, a ship gateway apparatus and a security system of the related art are apparatuses having no display and provide only simple status information, such as a power-on/off status of equipment and a network status, through a screen display device such as a light emitting diode (LED) or the like.

That is, in order to check setting status information of equipment, a display device is needed, or a status of a system may be checked in connection with a separate display device.

The related art is limited to a case of having a display device like ships, and a system sensitive to a security threat from the outside is insufficient to provide a security status of a ship.

Moreover, when a risk situation or a security threat situation occurs, there is a limitation in transferring information about the risk situation or the security threat situation to another system (for example, bridge alarm management (BAM)) of a ship.

### SUMMARY

Accordingly, the present invention provides a ship gateway apparatus and a status information displaying method thereof, which notify a security environment setting and a communication setting status of a gateway in a gateway apparatus connecting the inside of a ship to the outside like a generally used ship gateway apparatus (particularly, a mobile router apparatus that connects a mobile communication network (3rd generation (3G), long term evolution (LTE), WiBro, and/or the like) to a wireless local area network (WLAN).

The present invention also provides a ship gateway apparatus and a status information displaying method thereof, which provide a network status and status information indicating an abnormal situation to other systems connected to each other over a network, and when the abnormal situation occurs, display status information about the abnormal situation or notify the abnormal situation by using an alarm sound.

In one general aspect, a ship gateway apparatus includes: a network interface configured to provide an interface with an external network system; a data input unit configured to receive, through the network interface, data transmitted from the external network system; a network connection establisher configured to establish a connection with the external network system; a data processor configured to process data, based on establishment information about the connection with the external network system established by the network connection establisher; a data output unit configured to output data, obtained through processing by the data processor, to the network interface; and a switching unit configured to transfer data, input through the data input unit, to the data processor and output the data, obtained through processing by the data processor, to the data output unit.

The ship gateway apparatus may further include: a data status monitor configured to monitor a traffic status of the data obtained through processing by the data processor; an alarm unit configured to, when a traffic status alarm notification signal is received from the data status monitor, output alarm and warning; a setting manager configured to manage a setting status of the gateway; a timer configured to set a time for establishing a connection of the gateway; a display unit configured to display setting status information of the gateway set by the setting manager; and a firewall manager configured to manage a firewall of the gateway.

When the data input through the data input unit is abnormal data, the switching unit may transfer information about the abnormal data to the data status monitor.

The setting manager may manage a security environment setting and a communication establishment status of the gateway.

The data status monitor may identify a kind of the data obtained through processing by the data processor.

The data status monitor may receive traffic status information of data, blocked by the firewall of the gateway, through the switching unit.

The display unit may display alarm information generated by the alarm unit.

The display unit may display time information set by the timer.

The display unit may include: a voice communication status display unit configured to display information indicating whether voice communication is capable of being performed between a ship's internal system and the external network system; a direct data communication status display unit configured to display information indicating whether direct data communication is capable of being performed between the ship's internal system and the external network system; an indirect data communication status display unit configured to display information indicating whether indirect data communication is capable of being performed between the ship's internal system and the external network system; a disable status display unit configured to display information indicating whether a status of the gateway has been changed to a disable status; an operation status display unit configured to display an operation status of the gateway; a timer residual time display unit configured to display a residual time of the timer which remains up to a time when the direct data communication between the ship's internal system and the external network system ends; and a direct data communication time display unit configured to display a total elapse time of the direct data communication between the ship's internal system and the external network system.

The setting manager may change a direct data communication mode between the ship's internal system and the external network system to an indirect data communication mode or a voice communication mode.

In another general aspect, a status information displaying method performed by a ship gateway apparatus includes: setting a security environment of a ship's internal system and a communication status between the ship's internal system and an external network system; displaying in real time the security environment of the ship's internal system and the communication status between the ship's internal system and an external network system; and displaying alarm information when an abnormal situation occurs in the ship's internal system or the communication status between the ship's internal system and an external network system is abnormal.

The status information displaying method may further include transmitting the alarm information to a node of a network connected to the ship's internal system.

Other features and aspects will be apparent from the following detailed description, the drawings, and the claims.

### BRIEF DESCRIPTION OF THE DRAWINGS

FIG. 1 is a block diagram illustrating a configuration of a ship security gateway apparatus according to an embodiment of the present invention.

FIG. 2 is a block diagram illustrating a configuration of a display unit in the ship gateway apparatus of FIG. 1.

FIG. 3 is a flowchart illustrating a status information displaying method performed by a ship gateway apparatus according to an embodiment of the present invention.

### DETAILED DESCRIPTION OF EMBODIMENTS

Since the present invention may have diverse modified embodiments, preferred embodiments are illustrated in the drawings and are described in the detailed description of the present invention.

However, this does not limit the present invention within specific embodiments and it should be understood that the present invention covers all the modifications, equivalents, and replacements within the idea and technical scope of the present invention.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components. The present application, it should be understood that the term “connect” denotes a physical connection between elements described in the present specification and moreover includes an electrical connection and a network connection.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the invention will be described in detail with reference to the accompanying drawings. In describing the invention, to facilitate the entire understanding of the invention, like numbers refer to like elements throughout the description of the figures, and a repetitive description on the same element is not provided.

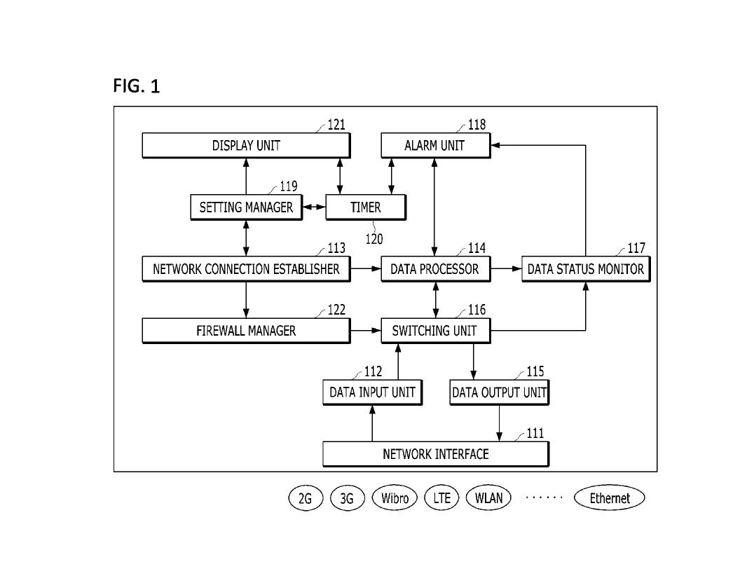

FIG. 1 is a block diagram illustrating a configuration of a ship security gateway apparatus according to an embodiment of the present invention.

Referring to FIG. 1, the ship gateway apparatus may include a network interface 111, a data input unit 112, a network connection establisher 113, a data processor 114, a data output unit 115, a switching unit 116, a data status monitor 117, an alarm unit 118, a setting manager 119, a timer 120, a display unit 121, and a firewall manager 122.

The network interface 111 may provide an interface, supported by the ship gateway apparatus, for various kinds of external network systems. Here, the external network systems may include 2^{nd} generator (2G), 3^{rd} generation (3G), Wibro, long term evolution (LTE), wireless local area network (WLAN), Ethernet, and/or the like.

The data input unit 112 may receive, through the network interface 111, data transmitted from an external network system.

The network connection establisher 113 may establish a connection between a ship's internal system and the external network system.

The data processor 114 may process data input/output through a gateway, based on connection establishment information between the external network system and the ship's internal system established by the network connection establisher 113.

The data output unit 115 may output data, obtained through processing by the data processor 114, to the network interface 111.

The switching unit 116 may transfer data, input from the data input unit 112, to the data processor 112 and may output data, obtained through processing by the data processor 114, to the data output unit 115.

When the data input from the data input unit 112 is abnormal data, the switching unit 116 may transfer information about the abnormal data to the data status monitor 117.

The switching unit 116 may determine whether to forward the data input from the data input unit 112 through switching/routing. For example, when undesired data is input, the switching unit 116 may transfer the undesired data to the data status monitor 117.

The data status monitor 117 may monitor a status of the gateway and a traffic status of the data obtained through processing by the data processor 114.

The data status monitor 117 may identify the kind of the data obtained through processing by the data processor 114.

The data status monitor 117 may identify switching information processed by the gateway through the data processor 114.

The data status monitor 117 may receive traffic status information of data, blocked by a firewall of the gateway, from the switching unit 116. When it is checked based on the received traffic status information that a security threat situation or a threat situation for traffic processing occurs in a network, the data status monitor 117 may transfer corresponding information to the alarm unit 118.

When a traffic status alarm notification signal is received from the data status monitor 117, the alarm unit 118 may output alarm and warning.

When alarm information is received from a node or an alarm or warning signal is received from the data status monitor 117, the alarm unit 118 may allow the display unit 121 to display details corresponding to the alarm or warning signal. Also, the alarm unit 118 may transmit the alarm or warning signal to a node (for example, an integrated navigation system or a bridge alarm management device) of the network.

The setting manager 119 may manage a setting status of the gateway. Particularly, the setting manager 119 may manage a security environment setting and a communication establishment status of the gateway.

The setting manager 119 may change a direct data communication mode between the ship's internal system and the external network system into an indirect communication mode or a voice communication mode. Here, the direct data communication mode may be a mode which is set in order for the gateway to perform communication between the ship's internal system and the external network system. Also, the indirect data communication mode may be a mode which is set to perform communication between the ship's internal system and the external network system through the gateway.

The timer 120 may set a time for a network connection of the gateway and a time for an environment setting of the gateway.

The display unit 121 may be a display unit for displaying a status of the gateway and may display setting status information of the gateway set by the setting manager 119. For example, the display unit 121 may display each of modes in an enable status, based on the direct data communication mode, the indirect data communication mode, or the voice communication mode.

The display unit 121 may display alarm or warning information generated by the alarm unit 118.

The display unit 121 may display time information set by the timer 120 in association with the network connection and environment setting of the gateway.

The firewall manager 122 may manage the firewall of the gateway.

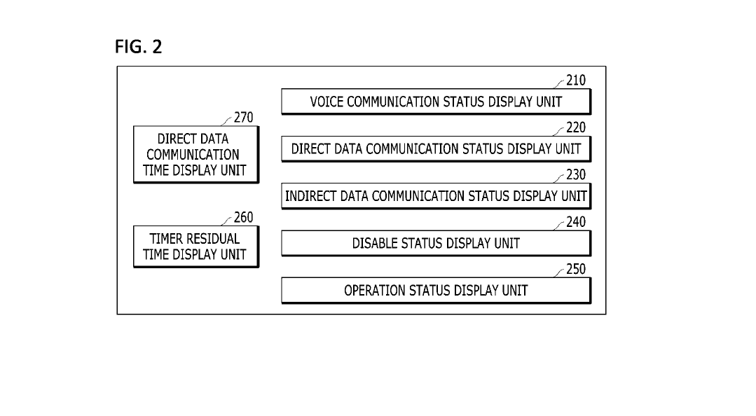

FIG. 2 is a block diagram illustrating a configuration of the display unit 121 in the ship gateway apparatus of FIG. 1.

Referring to FIG. 2, the display unit 121 according to an embodiment of the present invention may include a voice communication status display unit 210, a direct data communication status display unit 220, an indirect data communication status display unit 230, a disable status display unit 240, an operation status display unit 250, a timer residual time display unit 260, and a direct data communication time display unit 270.

The voice communication status display unit 210 may display information indicating whether voice communication is capable of being performed between the ship's internal system and the external network system. For example, when it is possible to perform the voice communication, the voice communication status display unit 210 may display an enable status in a voice communication mode.

The direct data communication status display unit 220 may display information indicating whether direct data communication is capable of being performed between the ship's internal system and the external network system. When it is set that the direct data communication is capable of being performed between the ship's internal system and the external network system, the direct data communication status display unit 220 may display an enable status in a direct data communication mode.

The indirect data communication status display unit 230 may display information indicating whether indirect data communication is capable of being performed between the ship's internal system and the external network system. When it is set that the indirect data communication is capable of being performed between the ship's internal system and the external network system, the indirect data communication status display unit 230 may display an enable status in an indirect data communication mode.

When an operation status of the gateway is remotely changed to a disable state or a status of the gateway is forcibly changed, the disable status display unit 240 may display the changed status.

The operation status display unit 250 may display a current operation status of the gateway. For example, the operation status display unit 250 may display information indicating whether a current status of the gateway is a normal status, an alarm status, or a warning status. When the current status of the gateway is the alarm status or the warning status, the operation status display unit 250 may continuously output an alarm sound.

The timer residual time display unit 260 may display a residual time of the timer 120 which remains up to a time when the direct data communication between the ship's internal system and the external network system ends.

The timer residual time display unit 260 may display, on a screen, a residual time in a unit time for which the direct data communication between the ship's internal system and the external network system is allowed. Here, when a timer residual time is reset, a time may be subtracted from the unit time or a predetermined time. Also, when the timer residual time display unit 260 displays 0, an alarm sound may be output once or more.

The direct data communication time display unit 270 may display a total elapse time of the direct data communication between the ship's internal system and the external network system. That is, the direct data communication time display unit 270 may display a total elapse time corresponding to a time which elapses up to a current time after a time when the direct data communication between the ship's internal system and the external network system starts.

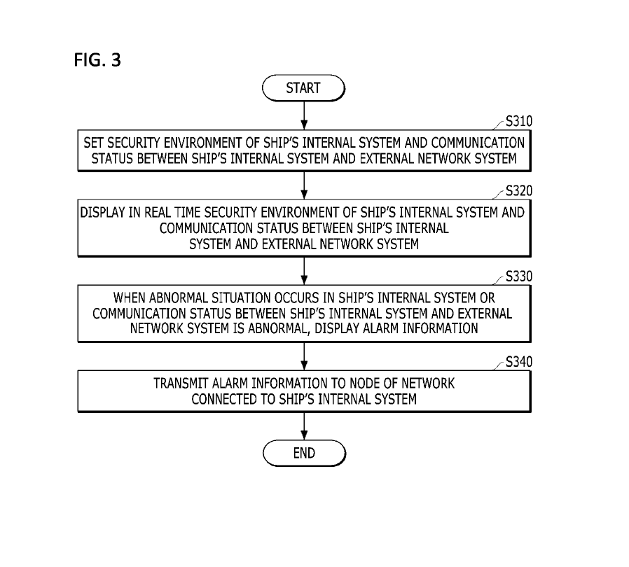

FIG. 3 is a flowchart illustrating a status information displaying method performed by the ship gateway apparatus according to an embodiment of the present invention.

Referring to FIG. 3, in step S310, the ship gateway apparatus may set a security environment of the ship's internal system and a communication status between the ship's internal system and the external network system.

In step S320, the ship gateway apparatus may display in real time the security environment of the ship's internal system and the communication status between the ship's internal system and the external network system. For example, the ship gateway apparatus may display each mode in an enable status, based on the direct data communication mode, the indirect data communication mode, or the voice communication mode which is set in the gateway.

When an abnormal situation occurs in the ship's internal system or the communication status between the ship's internal system and the external network system is abnormal, the ship gateway apparatus may display alarm information in step S330. That is, when a security threat situation or a threat situation for traffic processing occurs in the network, the ship gateway apparatus may display alarm information. In this case, the ship gateway apparatus may continuously generate an alarm sound while displaying the alarm information.

In step S340, the ship gateway apparatus may transmit the alarm information to a node of the network connected to the ship's internal system. For example, the ship gateway apparatus may transmit the alarm or warning signal to an integrated navigation system or a bridge alarm management device that is the node of the network. Also, the ship gateway apparatus may notify a risk situation through smartphones, connected to the ship gateway apparatus through the gateway, of passengers for a ship.

As described above, the ship gateway apparatus that connects the ship's internal system to the external network system may set a security environment for maintaining an internal security of a ship and may continuously display various network environment setting statuses in the display unit of the ship gateway apparatus. Also, when an abnormal situation occurs, the ship gateway apparatus may display alarm information or may continuously output an alarm sound, and may also transmit information indicating the abnormal situation to another internal system of the ship and another external system.

In the ship gateway apparatus and the status information displaying method thereof according to the embodiments of the present invention, even when a risk situation of each person occurs in a ship, rescue may be performed based on position information and status information about each person which are obtained through personal smart terminals connected to an internal communication network of the ship, and moreover, even when a ship is cast away, a rescue request and a rescue service may be performed for each person.

Moreover, the ship gateway apparatus and the status information displaying method thereof according to the embodiments of the present invention may be used in the gateway market for stable communication between an LTE router and a ship in ocean and between lands, and particularly, the ship gateway apparatus according to the embodiments of the present invention may be used as a small-ship gateway apparatus where it is difficult to install a separate device for checking a status of a gateway or a wired/wireless sharer.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A ship gateway apparatus comprising:
a network interface configured to provide an interface with an external network system;
a data input unit configured to receive, through the network interface, data transmitted from the external network system;
a network connection establisher configured to establish a connection with the external network system;
a data processor configured to process data, based on establishment information about the connection with the external network system established by the network connection establisher;
a data output unit configured to output data, obtained through processing by the data processor, to the network interface; and
a switching unit configured to transfer data, input through the data input unit, to the data processor and output the data, obtained through processing by the data processor, to the data output unit.

2. The ship gateway apparatus of claim 1, further comprising:
a data status monitor configured to monitor a traffic status of the data obtained through processing by the data processor;
an alarm unit configured to, when a traffic status alarm notification signal is received from the data status monitor, output alarm and warning;
a setting manager configured to manage a setting status of the gateway;
a timer configured to set a time for establishing a connection of the gateway;
a display unit configured to display setting status information of the gateway set by the setting manager; and
a firewall manager configured to manage a firewall of the gateway.

3. The ship gateway apparatus of claim 2, wherein when the data input through the data input unit is abnormal data, the switching unit transfers information about the abnormal data to the data status monitor.

4. The ship gateway apparatus of claim 2, wherein the setting manager manages a security environment setting and a communication establishment status of the gateway.

5. The ship gateway apparatus of claim 2, wherein the data status monitor identifies a kind of the data obtained through processing by the data processor.

6. The ship gateway apparatus of claim 2, wherein the data status monitor receives traffic status information of data, blocked by the firewall of the gateway, through the switching unit.

7. The ship gateway apparatus of claim 2, wherein the display unit displays alarm information generated by the alarm unit.

8. The ship gateway apparatus of claim 2, wherein the display unit displays time information set by the timer.

9. The ship gateway apparatus of claim 2, wherein the display unit comprises:
a voice communication status display unit configured to display information indicating whether voice communication is capable of being performed between a ship's internal system and the external network system;
a direct data communication status display unit configured to display information indicating whether direct data communication is capable of being performed between the ship's internal system and the external network system;
an indirect data communication status display unit configured to display information indicating whether indirect data communication is capable of being performed between the ship's internal system and the external network system;
a disable status display unit configured to display information indicating whether a status of the gateway has been changed to a disable status;
an operation status display unit configured to display an operation status of the gateway;
a timer residual time display unit configured to display a residual time of the timer which remains up to a time when the direct data communication between the ship's internal system and the external network system ends; and
a direct data communication time display unit configured to display a total elapse time of the direct data communication between the ship's internal system and the external network system.

10. The ship gateway apparatus of claim 9, wherein the setting manager changes a direct data communication mode between the ship's internal system and the external network system to an indirect data communication mode or a voice communication mode.

11. A status information displaying method performed by a ship gateway apparatus, the status information displaying method comprising:
setting a security environment of a ship's internal system and a communication status between the ship's internal system and an external network system;
displaying in real time the security environment of the ship's internal system and the communication status between the ship's internal system and an external network system; and
displaying alarm information when an abnormal situation occurs in the ship's internal system or the communication status between the ship's internal system and an external network system is abnormal.

12. The status information displaying method of claim 11, further comprising: transmitting the alarm information to a node of a network connected to the ship's internal system.
